(19) United States
(12) Patent Application Publication
(10) Pub. No.: US 2026/0158854 A1
(43) Pub. Date: Jun. 11, 2026

(54) COST-FUNCTION BASED OPTIMAL GRILLE SHUTTER CONTROL

(71) Applicant: Atieva, Inc, Newark, CA (US)

(72) Inventors: Adam Chapman, Hayward, CA (US); Sai Rajeev Devaragudi, Fremont, CA (US)

(21) Appl. No.: 18/704,363

(22) PCT Filed: Oct. 28, 2022
(86) PCT No.: PCT/US2022/078869

§ 371 Date: Apr. 24, 2024

Related U.S. Application Data
(60) Provisional application No. 63/263,174, filed on Oct. 28, 2021.

(51) Int. Cl. B60H 1/00; B60H 1/32; B60K 11/08

(52) U.S. Cl. CPC B60H 1/0073; B60H 1/00835; B60K 11/085; B60H 2001/3238

(57) ABSTRACT

A vehicle may include a body; a plurality of heat producing components within the body; an air intake through which air is provided from outside the body to dissipate heat from the heat-producing components; a shutter configured to control an amount of airflow through the air intake through control of a position of the shutter; and a controller configured to control the position of the shutter based on a cost function, wherein the cost function accounts for an aerodynamic drag of the vehicle and a rate of heat extraction from the heat-producing components, wherein the aerodynamic drag of the vehicle and the rate of heat extraction from the heat-producing components each depend on the position of the shutter.

### CROSS-REFERENCE TO RELATED APPLICATION

This application claims priority to U.S. Provisional Patent Application No. 63/263,174, filed on Oct. 28, 2021, and entitled “Cost-Function based Optimal Grille Shutter Control,” the disclosure of which is incorporated by reference herein in its entirety.

### TECHNICAL FIELD

This disclosure relates to thermal management in a vehicle and, in particular, to a cost-function-based control of a grille shutter.

### BACKGROUND

In recent years, the world's transportation has begun a transition away from powertrains primarily driven by fossil fuels and toward more sustainable energy sources, chiefly among them electric motors powered by on-board energy storages. In order to make these new modes of transportation available to larger segments of population, vehicle makers are striving to reduce the cost of manufacturing, including the cost of assembling battery packs to power electric motors.

### SUMMARY

In some aspects, the disclosure herein relates to a vehicle that includes a body and a plurality of heat producing components within the body. The vehicle includes an air intake through which air is provided from outside the body to dissipate heat from the heat-producing components and a shutter configured to control an amount of airflow through the air intake through control of a position of the shutter. A controller is configured to control the position of the shutter based on a cost function, where the cost function accounts for an aerodynamic drag of the vehicle and a rate of heat extraction from the heat-producing components, wherein the aerodynamic drag of the vehicle and the rate of heat extraction from the heat-producing components each depend on the position of the shutter.

Implementations can include one or more of the following features, along or in any combination with each other.

For example, the heat-producing components can include one or more of a battery, a power inverter, or an electric motor.

For example, the air intake can include a plurality of louvers and controlling the position of the shutter can include controlling an angle of the louvers.

For example, the vehicle can include a radiator configured to dissipate heat from the heat-producing components, the radiator being in thermal contact and communication with the heat-producing components and being configured to receive the air provided from the outside the body, and wherein the rate of heat extraction from the heat-producing components depends on a heat exchange of the radiator, the heat exchange of the radiator depending on the position of the shutter.

For example, the cost function can further account for a cost of pumping coolant through the radiator, where the cost of pumping coolant through the radiator depends on the position of the shutter.

For example, the vehicle can further include a refrigerant compressor configured to compress a low temperature vapor a high temperature vapor, and where the cost function further accounts for a cost of operating the compressor as a function of grille shutter position.

For example, the cost function can further account for a cost of changing the position of the shutter, such that the controller is configured to control the position of the shutter only by changing the position of the shutter if a change of the position of the shutter results in a change of the cost function, minus the cost of changing the position of the shutter, that exceeds a threshold amount.

In some aspects, the techniques described herein relate to a method of controlling an air intake of a vehicle, where the method includes determining a current position of a shutter that is configured for admitting air into the vehicle, the admitted air being used to dissipate heat from heat producing components within the vehicle, and determining a cost of operating the vehicle based the position of the shutter, the current cost being based on a first cost associated with an aerodynamic drag of the vehicle and a second cost associated with a rate of heat extraction from the heat-producing components, where the aerodynamic drag of the vehicle and the rate of heat extraction from the heat-producing components each depend on the position of the shutter. A first cost of operating the vehicle with the shutter in the current position is compared to a second cost of operating the vehicle with the shutter in a proposed position, the proposed position being different from the current position. The shutter is moved from the current position to the proposed position when the second cost is lower than the first cost.

Implementations can include one or more of the following features, along or in any combination with each other.

For example, the heat-producing components can include one or more of a battery, a power inverter, or an electric motor.

For example, the air intake can include a plurality of louvers and moving the shutter from the current position to the proposed position can include controlling an angle of the louvers.

For example, the vehicle can include a radiator configured to dissipate heat from the heat-producing components, the radiator being in thermal contact and communication with the heat-producing components and being configured to receive the air admitted into the vehicle, and the rate of heat extraction from the heat-producing components can depend on a heat exchange of the radiator, the heat exchange of the radiator depending on the position of the shutter.

For example, the cost function can further account for a cost of pumping coolant through the radiator, where the cost of pumping coolant through the radiator depends on the position of the shutter.

For example, the vehicle can further include a refrigerant compressor configured to compress a low temperature vapor a high temperature vapor, and the cost function can further account for a cost of operating the compressor as a function of grille shutter position.

For example, the cost function for operating the vehicle can be based on the position of the shutter being in the proposed position can further account for a cost of changing the position of the shutter from the current position to the proposed position.

### BRIEF DESCRIPTION OF DRAWINGS

FIG. 1 shows an example of a vehicle.

FIG. 2 illustrates an exemplary battery thermal management system suitable for use with a battery pack that can be used to power the vehicle.

FIG. 3 illustrates an alternate battery pack thermal management system also applicable to the battery pack cooling system of the present invention.

FIG. 4A is a graph of the aerodynamic drag coefficient of a vehicle as a function of the grille shutter position.

FIG. 4B is a graph of the volumetric airflow rate as a function of automated grille shutter position.

FIG. 5 illustrates an example architecture of a computing device that can be used to implement aspects of the present disclosure.

FIG. 6 is a flowchart of a process for controlling an air intake of a vehicle.

### DETAILED DESCRIPTION

This document describes examples of systems and techniques for improving the efficiency of operation of a vehicle. In particular, the airflow of air that is used to cool parts of the vehicle is managed to improve the efficiency of operation by dynamically performing a cost/benefit analysis based on how, and how much air, is admitted though an exterior of the vehicle to use to cool components within the vehicle (i.e., contained with an outer-facing exterior surface of the vehicle). Admitting air through the exterior of the vehicle can reduce power needed for cooling components of the vehicle, but also can increase the aerodynamic drag of the vehicle, resulting in an increased power drain on the vehicle. By dynamically determining different costs associated with admitting air through the exterior of the vehicle, an optimal amount of air to be admitted can be determined.

Examples described herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. A vehicle can be powered by one or more types of power sources. In some implementations, a vehicle is powered solely by electricity, or can use one or more other energy sources in addition to electricity, to name just a few examples.

As used herein, the terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system.

Examples herein refer to a vehicle chassis. A vehicle chassis is a framework that bears the load of the rest of the vehicle. A vehicle chassis can include one or more frames, which can be made of steel, aluminum alloy, or another stiff and strong material. For example, a vehicle chassis is sometimes made of at least two side rails connected by multiple cross members for structural integrity. One or more other components, including, but not limited to, a battery pack for an electric or hybrid vehicle, can be integrated into or otherwise combined with a vehicle chassis. A subframe is a chassis portion that can carry certain components, including but not limited to, a motor, drivetrain, or suspension, to spread chassis loads and/or isolate vibrations and harshness.

Examples herein refer to a vehicle body. A vehicle body is the main supporting structure of a vehicle to which components and subcomponents are attached. In vehicles having unibody construction, the vehicle body and the vehicle chassis are integrated into each other. As used herein, a vehicle chassis is described as supporting the vehicle body also when the vehicle body is an integral part of the vehicle chassis. The vehicle body often includes a passenger compartment with room for one or more occupants; one or more trunks or other storage compartments for cargo; and various panels and other closures providing protective and/or decorative cover.

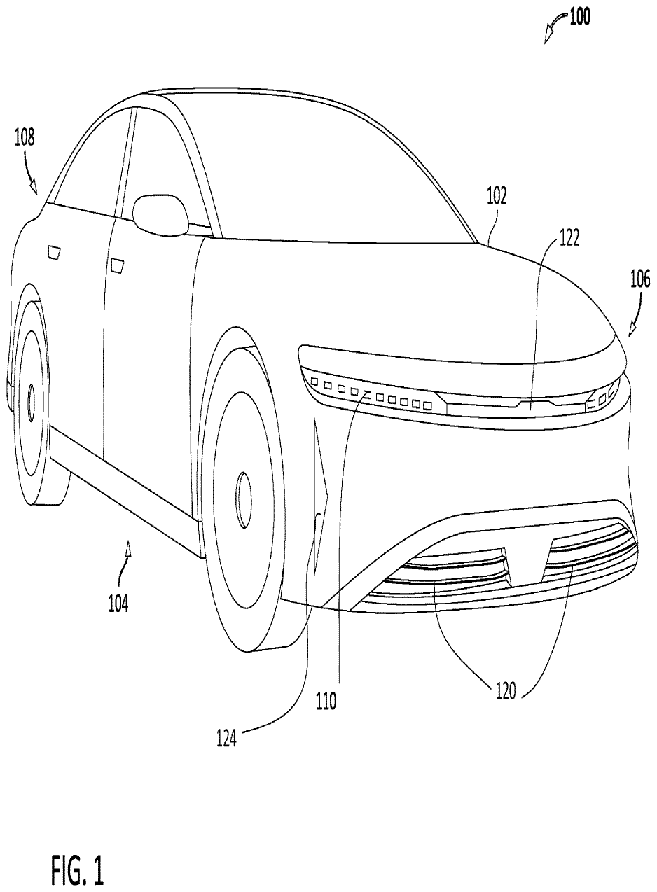

FIG. 1 shows an example of a vehicle 100. The vehicle 100 can be used with one or more other examples described elsewhere herein. The vehicle 100 includes a vehicle body 102 and a vehicle chassis 104 supporting the vehicle body 102. For example, the vehicle body 102 is here of a four-door type with room for at least four occupants, and the vehicle chassis 104 has four wheels. Other numbers of doors, types of vehicle body 102, and/or kinds of vehicle chassis 104 can be used in some implementations.

The vehicle body 102 has a front 106 and a rear 108. The vehicle 100 can have at least one motor, which can be positioned in one or more locations of the vehicle 100. In some implementations, the motor(s) can be mounted generally near the front 106, generally near the rear 108, or both. The vehicle 100 can have at least one lighting component, which can be situated in one or more locations of the vehicle 100. For example, the vehicle 100 can have one or more headlights 110 mounted generally near the front 106.

The vehicle 100 can include one or more air intakes 120, 122, 124 configured and meant for admitting air from outside the body 102 of the vehicle to within the body of the vehicle, where the admitted air can be used for thermal management of components of the vehicle. For example, the air admitted through the intakes 120, 122, 124 can be routed to one or more heat-producing devices (e.g., batteries, powertrain components, integrated circuits, etc.), radiators, or heat exchangers located within the vehicle 100 to promote the dissipation of heat from the objects to which the air is routed.

One or more of the air intakes 120, 122, 124 can be equipped with a movable shutter that can open to admit air through the intake and that can close to block air from entering through the intake. In addition, a position of a shutter can be controlled between a fully open and a fully closed position to control a flow rate of air through the associated intake. For example, a shutter associated with an air intake 120, 122, 124 can include one or more movable louvers whose position can be adjusted to control the flow of ambient air through the air intake from outside the body of the vehicle to inside the body. In some implementations, the shutter can be known as a grille shutter, for example, when air intake and the shutter are located behind a grille of the vehicle.

In addition to controlling the amount of air that flows through an air intake 120, 122, 124, a position of the shutter associated with an air intake also can affect a drag coefficient (C_{D}) of the vehicle 100. For example, with the shutter(s) of the one or more air intakes 120, 122, 124 closed, a smooth outer profile of the body 102 of the vehicle 100 can be maintained, and the drag coefficient of the vehicle can be relatively low. However, with the shutter(s) of the one or more air intakes 120, 122, 124 open, the profile of the body 102 of the vehicle 100 can be more irregular, causing greater turbulence and drag in the airflow around the vehicle, and thus the drag coefficient of the vehicle can be relatively high. Intermediate positions of the shutter(s) can result in intermediate values of the drag coefficient of the vehicle 100.

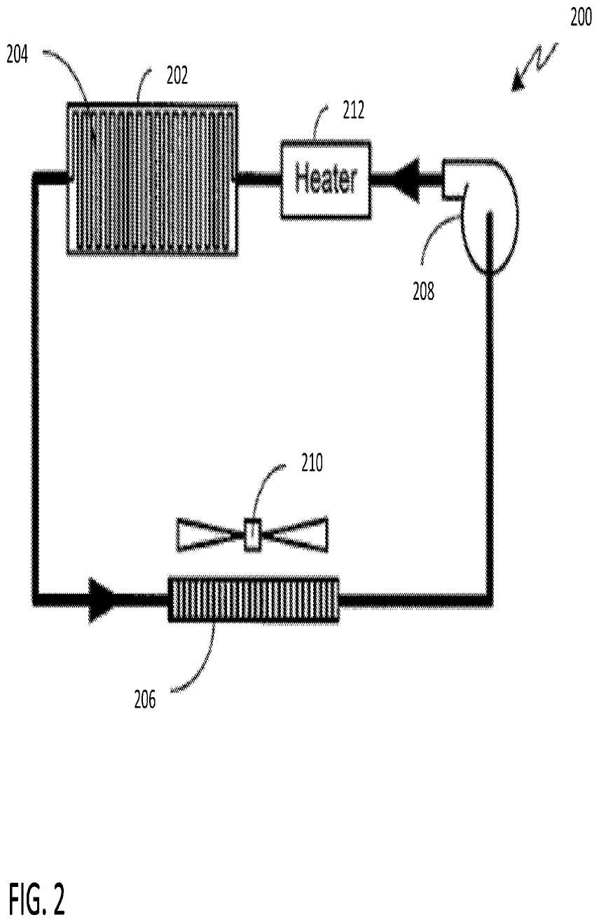

FIG. 2 illustrates an exemplary battery thermal management system 200 suitable for use with a battery pack that can be used to power the vehicle 100. In system 200, the temperature of the batteries within battery pack 202 is controlled by pumping a thermal transfer medium, e.g., a liquid coolant, through a plurality of battery cooling conduits 204. Cooling conduits may be integrated into battery pack 202 or coupled to an exterior surface of battery pack 202. Conduits 204, which are in thermal communication with the batteries within pack 202, provide a means of controlling the temperature of the batteries by regulating the flow of coolant within conduits 204 and/or regulating the transfer of heat from the coolant to another temperature control system. In the embodiment illustrated in FIG. 2, the coolant within conduits 204 is pumped through a radiator 206 using a pump 208.

In some implementations, airflow (e.g., due movement of the vehicle though the air and the air entering the one or more inlets 120) of ambient air from outside the body of the vehicle can be provided through one or more air intakes 120, 122, 124 to the radiator 206 to remove heat from the radiator. In some implementations, a blower fan 210 may be used to force air through radiator 206, for example, when the car is stationary or moving at low speeds, thus ensuring that there is an adequate transfer of thermal energy from the coolant to the ambient environment. System 200 may also include a heater 212, e.g., a PTC heater, that may be used to heat the coolant within conduits 204, and thus heat the batteries within pack 101. Battery heating via a supplemental heat source 212 or by coupling the battery pack coolant loop to various drive train components (e.g., motor, power inverter, transmission, etc.) may be necessary to maintain battery temperature within the desired operating range, for example, when the ambient temperature is too low or during initial vehicle operation. Thus, the provision of airflow provided through one or more air intakes 120, 122, 124 to the radiator 206 to remove heat from the battery pack 202 and the provision of heat from heat source 212 can be controlled to maintain battery temperature within the desired operating range.

Similarly, heat can be dissipated from other heat producing components (e.g., power inverters, electric motors, etc.) of the vehicle through structures and techniques similar to those illustrated in FIG. 2. For example, a heat producing component can be in thermal contact and communication with a radiator, for example, by circulating coolant liquid between the heat producing component and the radiator, and heat can be extracted from the radiator through the provision of ambient air from outside the vehicle to the radiator to remove heat from the radiator. Efficiency of the vehicle can be improved by extracting heat from the radiator to maintain a temperature of the heat producing components at temperatures at which the components operate most efficiently.

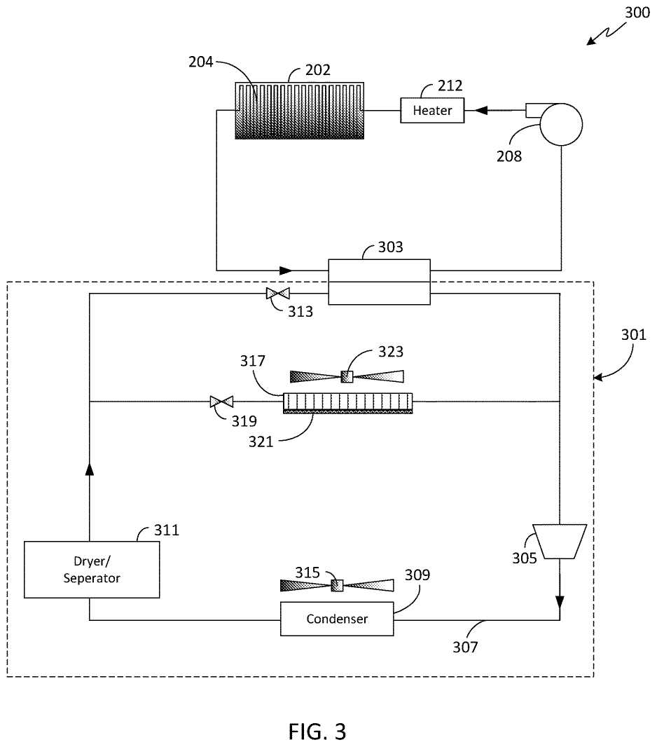

FIG. 3 illustrates an alternate battery pack thermal management system 300 also applicable to the battery pack cooling system of the present invention. In system 300, the coolant within conduits 204 is coupled to a secondary thermal management system 301 via a heat exchanger 303. The thermal management system 301 can include a refrigeration system and as such, can include a refrigerant compressor 305 to compress the low temperature vapor in refrigerant line 307 into a high temperature vapor and a condenser 309 in which a portion of the captured heat is dissipated. After passing through condenser 309, the refrigerant changes phase from vapor to liquid, the liquid remaining at a temperature below the saturation temperature at the prevailing pressure. The refrigerant then passes through a dryer 311 that removes moisture from the condensed refrigerant. After dryer 311, refrigerant line 307 is coupled to heat exchanger 303 via thermal expansion valve 313 which controls the flow rate of refrigerant into heat exchanger 303. Additionally, in the illustrated system a blower fan 315 is used in conjunction with condenser 309 to improve system efficiency.

In a typical vehicle configuration, thermal management system 301 is also coupled to the vehicle's heating, ventilation and air conditioning (HVAC) system. In such a system, in addition to coupling refrigerant line 307 to heat exchanger 303, line 307 may also be coupled to the HVAC evaporator 317. A thermal expansion valve 319 is preferably used to control refrigerant flow rate into the evaporator. A heater, for example a PCT heater 321 integrated into evaporator 317, may be used to provide warm air to the passenger cabin. In a conventional HVAC system, one or more fans 323 are used to circulate air throughout the passenger cabin, where the circulating air may be ambient air, air cooled via evaporator 317, or air heated by heater 321.

In some electric vehicles, battery pack cooling is accomplished using a combination of a radiator such as that shown in FIG. 2, and a heat exchanger such as that shown in FIG. 3. In such a system, the coolant passing through the battery pack 202 via conduits 204 may be directed through either a radiator or a heat exchanger, and a valve can control the flow of coolant through the radiator.

Similarly, heat can be dissipated from other heat producing components (e.g., power inverters, electric motors, etc.) of the vehicle through structures and techniques similar to those illustrated in FIG. 3. For example, a heat producing component can be in thermal contact and communication with a radiator, for example, by circulating coolant liquid between the heat producing component and the radiator, and heat can be extracted from the radiator through the provision of ambient air from outside the vehicle to the radiator to remove heat from the radiator. Efficiency of the vehicle can be improved by extracting heat from the radiator to maintain a temperature of the heat producing components at temperatures at which the components operate most efficiently.

Thus, actuating a grille shutter controller to open a shutter associated with an air intake 120, 122, 124 to allow ambient air to flow from outside the body of the vehicle 100 inside the body of the vehicle to cool components of the vehicle can help maintain an operating temperature of the components of the vehicle at a value, or within a range of values, that results in efficient operation of the vehicle. However, as mentioned above, operating the vehicle with one or more shutters associated with an air intake 120, 122, 124 in an open state also can result in an increased drag coefficient of the vehicle, which results in increased aerodynamic drag when the vehicle is moving and therefore a decrease in efficiency of the vehicle.

To balance the benefits of admitting air through the air intakes 120, 122, 124 for the purpose of thermal management of components of the vehicle against the cost of increased aerodynamic drag due to admitting air through the air intakes, a cost function that accounts for the benefits and costs of a grille shutter having different positions, ranging from fully closed to fully open, can be calculated, and the grille shutter position can be dynamically controlled to minimize the cost value of the cost function.

The cost function can include a weighted sum of terms that account for vehicle power to overcome aerodynamic drag power, cooling pump power, and refrigerant compressor power consumption, minus a weighted heat exchange. An additional term can account for moving the grille shutter from its current position is added to prevent rapid cycling of the actuator of the grille shutter. Thus, a cost (J_{GSP}) associated with a grille shutter position can be expressed as a function:

$${J}_{GSP} = {J}_{aero} \cdot {w}_{aero} + {J}_{pump} \cdot {w}_{pump} + {J}_{cmpr} \cdot {w}_{cmpr} - {J}_{{PT}_{coolg}} \cdot {w}_{{PT}_{temp}} + {J}_{{pos}_{GSP}} \cdot {w}_{{pos}_{GSP}} where the terms of the cost function include : \qquad ( 1 )$$

$${J}_{aero} = {J}_{aero} ( GSP ) = Power used to overcome aerodynamic drag , when the grille shutter is in a determined position ,$$

$${J}_{pump} = {J}_{pump} ( GSP ) = Power consumed by pumps to pump coolant through the radiator , when the grille shutter is in the determined position ,$$

$${J}_{cmpr} = {J}_{cmpr} ( GSP ) = Power consumed by refriferant compressor , when the grille shutter is in the determined position ,$$

$${J}_{{PT}_{coolg}} = {J}_{{PT}_{coolg}} ( GSP ) = Powertrain cooling cost , when the grille shutter is in the determined position ,$$

$${J}_{{pos}_{GS}} = {J}_{{pos}_{GS}} ( GSP ) = cost of moving grille shutter from the determined position ,$$

$${w}_{xxx} = weighting factor of individual cost in the total cost function .$$

The optimal grille shutter position to apply at any point in time is the position that minimizes the total cost J_{GSP}. The shutter position can be expressed by different metrics, depending on how the shutter operates. For example, if the shutter operates as a louver that changes its angle relative to a fixed plane to open and close the airflow, the position can be expressed as an angle. If the shutter operates as a sliding panel, like a sliding door, or if the shutter operates like the aperture of a camera shutter, the position can be expressed as an opening percentage between zero and 100%.

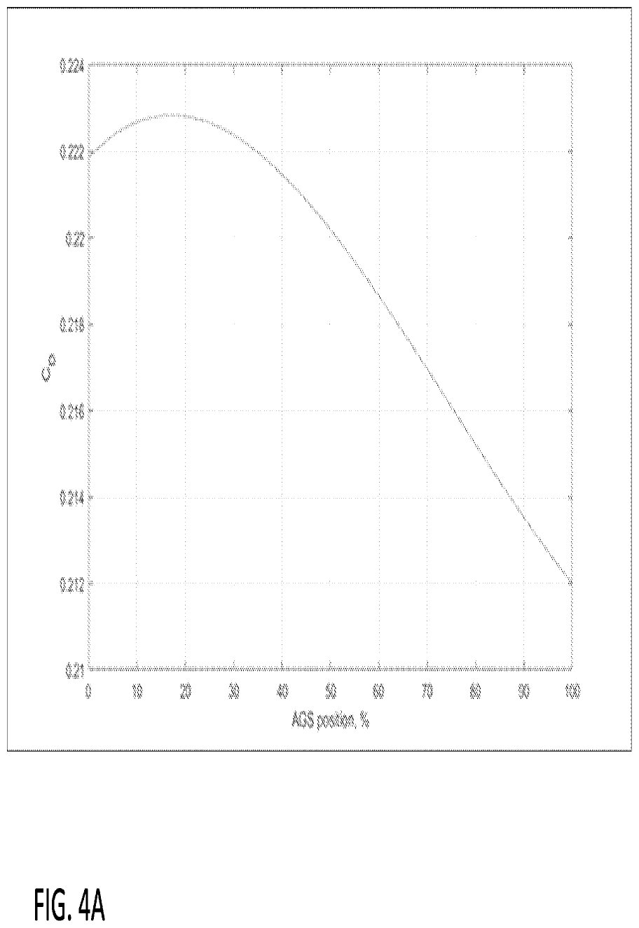

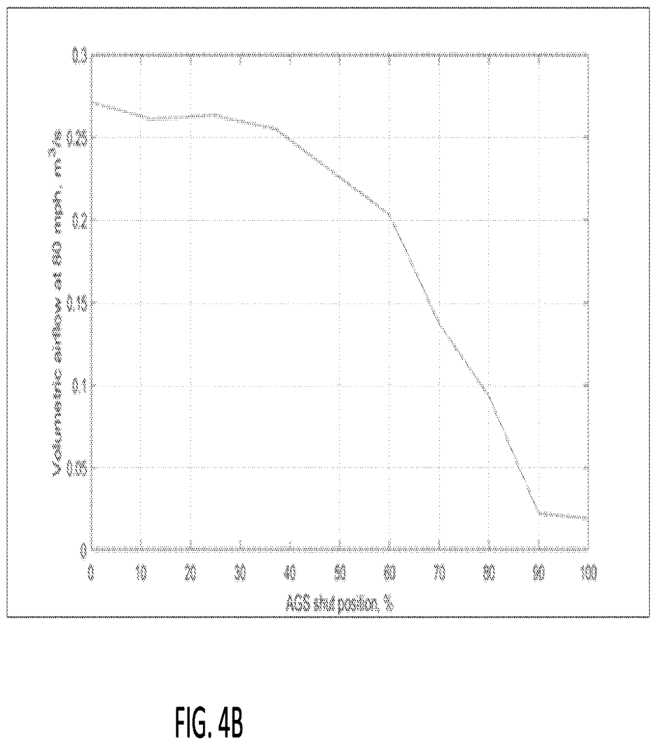

The term, Jₐₑᵣₒ, that accounts for the cost of aerodynamic drag on the vehicle can be understood as the power required to overcome aerodynamic drag:

$${J}_{aero} = \frac{1}{2} ρ {C}_{D} A . {V}^{3} , \qquad ( 2 )$$

where ρ is the air density at sea level (1.225 kg/m²), V is the vehicle forward velocity, A is the frontal area of the vehicle and C_{D} is the aerodynamic drag coefficient associated for a given grille shutter position. The aerodynamic drag coefficient (C_{D}) as a function of the grille shutter position is presented in FIG. 4A, where the automated grille shutter (AGS) position ranges from 0% (fully open) to 100% (fully closed). Thus, the aerodynamic drag cost increases as the grille shutter position changes from 100% closed to about 17% closed and then decreases as the grille shutter position becomes completely open.

The term, Jₚᵤₘₚ, that accounts for the cost of operating the coolant pump can be calculated as the summed power of coolant pumps (e.g., front and back pumps) that affect radiator coolant flow: Jₚᵤₘₚ=W_{PTFrnt}+W_{PTRear}. In some implementations, pump speed is not optimized for minimal power consumption, but rather the pumps are controlled to increase their speed with powertrain component temperatures, thus increasing radiator coolant flow as the powertrain gets warmer. The resulting coolant massflow can be used to calculate radiator heat exchange as a function of grille shutter position. The term, Jₚᵤₘₚ, can depend on the position of the shutter, because with relatively little airflow to the radiator, relatively more coolant may need to be pumped through the radiator, thus increasing the cost of operating the coolant pump.

In some implementations, the term, J_{cmpr}, that accounts for the cost of operating the compressor as a function of grille shutter position can be based on experimentally determined pressure differences (difference between compressor suction and discharge temperatures) vs outside air temperatures and grille shutter angle.

In some implementations, the term, J_{cmpr}, that accounts for the cost of operating the compressor as a function of grille shutter position can be modeled or determined and written to a lookup table that can be used in the cost function. In the lookup table approach, the current outside air temperature can be used to look up a vector of refrigerant pressure differences. That vector of pressure differences then can be normalized with the current outside temperature and measured pressure difference to estimate what the pressure difference would be if the grille shutter angle were changed at a point in time. The normalization step corrects the lookup table for differences in freestream airflow and condenser heat load from the conditions under which the experimental table was recorded. The compressor power for different grille shutter angles then can be predicted using:

$${J}_{cmpr} = {W}_{cmpr} = 98.4 + 156.8 ( {P}_{condsr} - {P}_{evapr} ) . \qquad ( 3 )$$

The Compressor pressure difference lookup table of values for P_{condsr}−Pₑᵥₐₚᵣ is presented in Table 1.

TABLE 1

| | | AGS posiiton, % | | | | | |
|---|---|---|---|---|---|---|---|
| | | 0 | 20 | 40 | 60 | 80 | 100 |
| Ambient Air | 15 | 2.3 | 2.4 | 2.4 | 2.6 | 2.7 | 5.0 |
| Temperature, | 20 | 2.9 | 2.9 | 3.0 | 3.2 | 3.3 | 8.0 |
| deg C. | 25 | 4.5 | 4.6 | 5.2 | 6.2 | 7.0 | 12.8 |
| | 30 | 7.4 | 7.4 | 7.7 | 8.0 | 9.4 | 15.2 |
| | 35 | 9.4 | 9.4 | 9.6 | 10.2 | 11.9 | 19.3 |
| | 40 | 11.3 | 11.8 | 11.9 | 12.7 | 14.6 | 23.7 |
| | 45 | 13.2 | 14.3 | 14.1 | 15.2 | 17.3 | 28.1 |

In some implementations, the term, Jₚₒₛ_{_{GS}} that accounts for the cost of moving the grille shutter can discourage movement of the shutter unless such movement would results in a change in the cost function that exceeds a threshold amount. For example, Jₚₒₛ_{_{GS}} can be a constant value associated with any change of the shutter position, such that the sum of other terms of the cost function must exceed Jₚₒₛ_{_{GS}} to justify changing the position of the shutter. Thus, large, fast movements in grille shutter position can result in a higher cost until the aerodynamic and cooling costs reach a similar magnitude, with the result being slower, smoother movements in grille shutter position, and an improvement in the lifespan of an actuator of the movement of the shutter position.

The term, J_{PT}_{_{coolg}}, that accounts for the powertrain cooling cost (which is proportional to a rate of heat extraction from the powertrain) can be expressed as the sum of two terms that account for the cost of cooling a power inverter and the cost of cooling the motor, where the value of each term depends on the temperature of the inverter and the motor, respectively, and also on the heat exchange that occurs in the radiator. The radiator heat exchange (Q_{rad}(AGS)) can be calculated and is a function of the grille shutter position, because the grille shutter position affects the amount of airflow through the radiation and therefore the heat exchanged by the radiator. Thus, J_{PT}_{_{coolg}} can be expressed as:

$${J}_{{PT}_{coolg}} = {Q}_{rad} ( AGS ) {T}_{ivtr} {w}_{ivtr} + {Q}_{rad} ( AGS ) {T}_{mot} {w}_{mot} {\vert}_{{T}_{oil} > 52} \qquad ( 4 )$$

where wₘₒₜ and wᵢᵥₜᵣ sum to equal 1. The term J_{PT}_{_{coolg}} is denominated as a cost, but one of skill in the art appreciates that cooling the powertrain, including a power inverter and a motor of the vehicle, can improve the efficacy of the vehicle's operation, and therefore higher values of J_{PT}_{_{coolg}} are associated with more efficient operation of the vehicle. Because the powertrain cooling cost is subtracted from the overall cost function of eqn. (1), the hotter the powertrain is (i.e., the higher the temperatures of the inverter and the motor in eqn. (4) are), the more the overall cost is reduced by opening the grille shutter

Before calculating the radiator heat exchange for different grille shutter angles, the radiator heat exchange must be calculated for the current grille shutter position. In some implementations, the vehicle does not measure coolant temperature on both sides of the radiator, but rather only measures the coolant temperature downstream of the radiator is measured. Thus, to estimate the radiator heat exchange at any given time, we calculate what the outlet temperature would be over a vector of input coolant temperatures, and then interpolate the measured downstream coolant temperature.

The radiator heat exchange can be calculated from the following model that accounts for the air side of the radiator and the coolant side.

On the air side, the heat capacity of air, (Cₐᵢᵣ) is calculated from Cₐᵢᵣ=\dot{m}ₐᵢᵣcₚ_{ₐᵢᵣ}, where cₚ_{ₐᵢᵣ} is a constant 1005 J/kgK and the air mass flow rate (\dot{m}ₐᵢᵣ) is the product of mean radiator volumetric airflow rate and air density, \dot{m}ₐᵢᵣ=\dot{u}ₐᵢᵣρₐᵢᵣ. The volumetric airflow rate (\dot{u}ₐᵢᵣ) can be determined from a lookup table derived from wind tunnel experiments with 80 mph freestream airflow with different automated grille shutter (AGS) positions. The volumetric airflow rate as a function of AGS position is shown in FIG. 4B. To adjust for instantaneous road speed, \dot{v}ₐᵢᵣ can be multiplied by road speed and divided by 80 mph.

The ideal gas law equation is rearranged to estimate air density at sea level with temperature:

$${ρ}_{air} = \frac{R \cdot {P}_{air}}{{T}_{air}} \qquad ( 5 )$$

where Pₐᵢᵣ is sea-level air pressure from the international standard atmosphere (ISA) model, R is the ideal gas constant and Tₐᵢᵣ is expressed in Kelvin.

The radiator's air-side convectance hA is calculated with

$${hA}_{air} = \frac{{Nu}_{air} \cdot {K}_{air}}{{d}_{{h}_{air}}} \qquad ( 6 )$$

where K is the thermal conductivity of air, dₕ is the air-side hydraulic diameter of the radiator and Nuₐᵢᵣ is the air Nusselt number, and the average Nusselt number is approximated from an empirical correlation of experimental data:

$${Nu}_{air} = 0.575 \cdot {Re}_{air}^{0.5} , \qquad ( 7 )$$

where Re is the Air-side Reynolds Number, calculated from

$${Re}_{air} = \frac{{ρ}_{air} \cdot {u}_{air} \cdot {d}_{{h}_{air}}}{{μ}_{air}} . \qquad ( 8 )$$

On the coolant side, the coolant heat capacity C_{coolt} is calculated from:

$${C}_{coolt} = {\dot{m}}_{coolt} {c}_{{p}_{coolt}} = {ρ}_{cool} {\dot{v}}_{c o o l} {c}_{{p}_{coolt}} \qquad ( 9 )$$

where Cₚ_{_{coolt}} is determined by interpolating radiator coolant inlet temperature between [−40 deg C., 3023 J/kgK] and [140 deg C., 3743.9 J/kgK].

The Coolant mass flow rate is simply the product of coolant density ρ_{coolt} and volumetric flow rate \dot{v}_{coolt} is calculated from

$${C}_{coolt} = {ρ}_{coolt} {\dot{v}}_{coolt} {c}_{{p}_{coolt}} , \qquad ( 10 )$$

where coolant density ρ_{coolt} is approximated with the empirical curve fit of density with coolant outlet temperature

$${ρ}_{coolt} = 1082.4 - 0.3 \; 498 {T}_{coolt} - 0.0 \; 024 {T}_{coolt}^{2} , \qquad ( 11 )$$

and pump flow rate \dot{v}_{coolt} is approximated from pump duty and power draw with an empirical fit for the vehicle.

The radiator's coolant-side convectance hA is calculated with

$${hA}_{coolt} = \frac{{Nu}_{coolt} \cdot {K}_{coolt}}{{d}_{{h}_{coolt}}} , \qquad ( 12 )$$

where K_{coolant} is the thermal conductivity of coolant, d_{hcoolt} is the coolant-side hydraulic diameter of the radiator, and Nu_{coolt} is the coolant Nusselt number. K_{coolant} is approximated by:

$${K}_{coolt} = 0.61 + 9.02 \times 1 {0}^{- 4} {T}_{coolt} - 3.72 \times 1 {0}^{- 6} {T}_{coolt}^{2} . \qquad ( 13 )$$

The average Nusselt number is approximated from an empirical correlation:

$${Nu}_{air} = 0.066 \cdot {Re}_{coolt}^{0.75} , \qquad ( 14 )$$

where Re_{coolt} is the coolant Reynolds number:

$${Re}_{coolt} = \frac{{ρ}_{coolt} \cdot {u}_{coolt} \cdot {d}_{{h}_{coolt}}}{{μ}_{coolt}} .$$

The coolant viscosity μ_{coolt} is approximated by

$${μ}_{coolt} = {e}^{( - 4.75 - 0.0452 {T}_{coolt} + 3.09 \times 1 {0}^{- 4} {T}_{coolt}^{2} - 1.05 \times {10}^{- 6} {T}_{coolt}^{3} )} . \qquad ( 15 )$$

For the Radiator Heat Exchange, the number of thermal units (NTU) exchanged by the radiator is

$$NTU = \frac{UA}{{c}_{min}} \qquad ( 16 )$$

with convectance UA given by:

$$UA = 1 / ( \frac{1}{{hA}_{air}} + \frac{1}{{hA}_{coolt}} ) \qquad ( 17 )$$

and limiting heat capacity Cₘᵢₙ=min[Cₐᵢᵣ, C_{coolt}]. The radiator effectiveness is then calculated with:

$$ε = 1 - {e}^{\{ \frac{{NTU}^{0.22}}{{C}_{r}} [ {e}^{( - {C}_{r} \cdot {NTU}^{0.78} )} - 1 ] \}} . \qquad ( 18 )$$

Finally, the radiator heat exchange is calculated from the radiator effectiveness, limiting heat capacity, and difference between coolant and air inlet temperatures:

$${Q}_{radr} = ε \cdot {C}_{min} ( {T}_{coolt} - {T}_{air} ) . \qquad ( 19 )$$

Control of the grille shutter position can be performed by one or more controllers or processors (e.g., computers or microprocessors) based on a cost function, similar to the one described above.

Simulations of the cost-function grille shutter control based on the multiple inputs described above to an overall cost function for the vehicle have shown a 2% reduction in total vehicle power consumption compared to a simple proportional control of the grille shutter position based only on powertrain temperature.

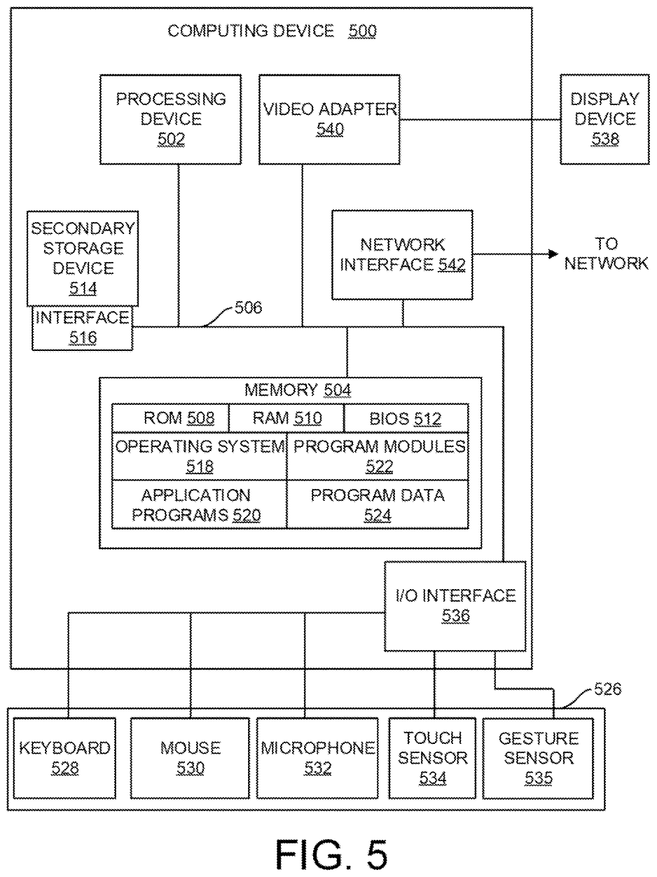

FIG. 5 illustrates an example architecture of a computing device 500 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 5 can be used to perform the techniques (e.g., to execute the operating system, application programs, and/or software modules (including the software engines)) described herein.

The computing device 500 includes, in some embodiments, at least one processing device 502 (e.g., a processor), such as a central processing unit (CPU). A variety of processing devices are available from a variety of manufacturers, for example, Intel or Advanced Micro Devices. In this example, the computing device 500 also includes a system memory 504, and a system bus 506 that couples various system components including the system memory 504 to the processing device 502. The system bus 506 is one of any number of types of bus structures that can be used, including, but not limited to, a memory bus, or memory controller; a peripheral bus; and a local bus using any of a variety of bus architectures.

Examples of computing devices that can be implemented using the computing device 500 include a desktop computer, a laptop computer, a tablet computer, a mobile computing device (such as a smart phone, a touchpad mobile digital device, or other mobile devices), or other devices configured to process digital instructions.

The system memory 504 includes read only memory 508 and random access memory 510. A basic input/output system 512 containing the basic routines that act to transfer information within computing device 500, such as during start up, can be stored in the read only memory 508.

The computing device 500 also includes a secondary storage device 514 in some embodiments, such as a hard disk drive, for storing digital data. The secondary storage device 514 is connected to the system bus 506 by a secondary storage interface 516. The secondary storage device 514 and its associated computer readable media provide nonvolatile and non-transitory storage of computer readable instructions (including application programs and program modules), data structures, and other data for the computing device 500.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 514 and/or system memory 504, including an operating system 518, one or more application programs 520, other program modules 522 (such as the software engines described herein), and program data 524. The computing device 500 can utilize any suitable operating system.

In some embodiments, a user provides inputs to the computing device 500 through one or more input devices 526. Examples of input devices 526 include a keyboard 528, mouse 530, microphone 532 (e.g., for voice and/or other audio input), touch sensor 534 (such as a touchpad or touch sensitive display), and gesture sensor 535 (e.g., for gestural input). In some implementations, the input device(s) 526 provide detection based on presence, proximity, and/or motion. Other embodiments include other input devices 526. The input devices can be connected to the processing device 502 through an input/output interface 536 that is coupled to the system bus 506. These input devices 526 can be connected by any number of input/output interfaces, such as a parallel port, serial port, game port, or a universal serial bus. Wireless communication between input devices 526 and the input/output interface 536 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 538, such as a monitor, liquid crystal display device, light-emitting diode display device, projector, or touch sensitive display device, is also connected to the system bus 506 via an interface, such as a video adapter 540. In addition to the display device 538, the computing device 500 can include various other peripheral devices (not shown), such as speakers or a printer.

The computing device 500 can be connected to one or more networks through a network interface 542. The network interface 542 can provide for wired and/or wireless communication. In some implementations, the network interface 542 can include one or more antennas for transmitting and/or receiving wireless signals. When used in a local area networking environment or a wide area networking environment (such as the Internet), the network interface 542 can include an Ethernet interface. Other possible embodiments use other communication devices. For example, some embodiments of the computing device 500 include a modem for communicating across the network.

The computing device 500 can include at least some form of computer readable media. Computer readable media includes any available media that can be accessed by the computing device 500. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 500.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 5 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 500 can be characterized as an ADAS computer. For example, the computing device 500 can include one or more components sometimes used for processing tasks that occur in the field of artificial intelligence (AI). The computing device 500 then includes sufficient proceeding power and necessary support architecture for the demands of ADAS or AI in general. For example, the processing device 502 can include a multicore architecture. As another example, the computing device 500 can include one or more co-processors in addition to, or as part of, the processing device 502. In some implementations, at least one hardware accelerator can be coupled to the system bus 506. For example, a graphics processing unit can be used. In some implementations, the computing device 500 can implement a neural network-specific hardware to handle one or more ADAS tasks.

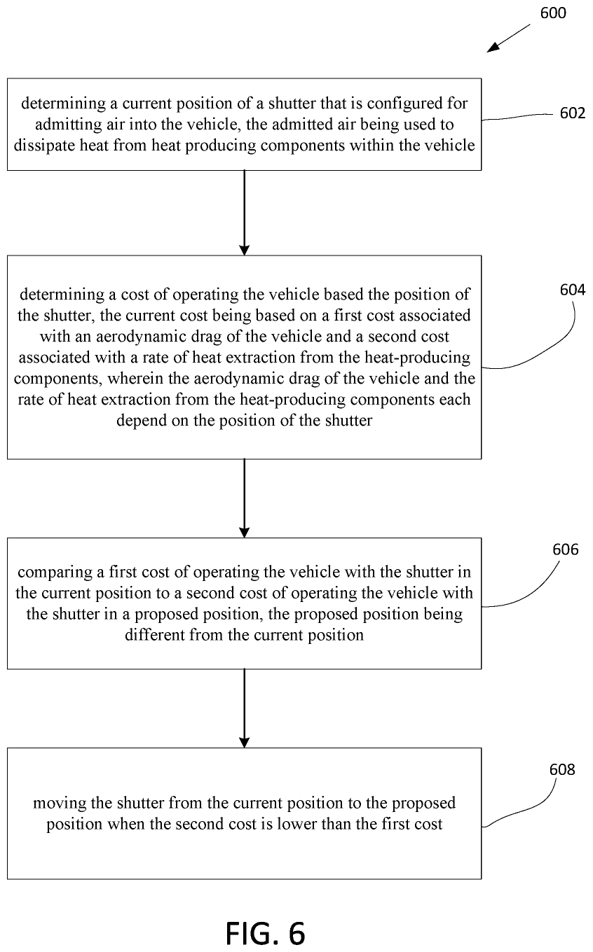

FIG. 6 is a flowchart of a process 600 for controlling an air intake of a vehicle. The process 600 includes determining a current position of a shutter that is configured for admitting air into the vehicle, the admitted air being used to dissipate heat from heat producing components within the vehicle (602). The process 600 further includes determining a cost of operating the vehicle based the position of the shutter, the current cost being based on a first cost associated with an aerodynamic drag of the vehicle and a second cost associated with a rate of heat extraction from the heat-producing components, wherein the aerodynamic drag of the vehicle and the rate of heat extraction from the heat-producing components each depend on the position of the shutter (604). The process 600 further includes comparing a first cost of operating the vehicle with the shutter in the current position to a second cost of operating the vehicle with the shutter in a proposed position, the proposed position being different from the current position (606). The process 600 further includes moving the shutter from the current position to the proposed position when the second cost is lower than the first cost (608).

The terms “substantially” and “about” used throughout this Specification are used to describe and account for small fluctuations, such as due to variations in processing. For example, they can refer to less than or equal to ±5%, such as less than or equal to ±2%, such as less than or equal to #1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter appearing in this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems.

While certain features of the described implementations have been illustrated as described herein, many modifications, substitutions, changes and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the invention.

1. A vehicle comprising:
a body;
a plurality of heat producing components within the body;
an air intake through which air is provided from outside the body to dissipate heat from the heat-producing components;
a shutter configured to control an amount of airflow through the air intake through control of a position of the shutter; and
a controller configured to control the position of the shutter based on a cost function, wherein the cost function accounts for an aerodynamic drag of the vehicle and a rate of heat extraction from the heat-producing components, wherein the aerodynamic drag of the vehicle and the rate of heat extraction from the heat-producing components each depend on the position of the shutter.

2. The vehicle of claim 1, wherein the heat-producing components include one or more of a battery, a power inverter, or an electric motor.

3. The vehicle of claim 1, wherein the air intake includes a plurality of louvers and wherein controlling the position of the shutter includes controlling an angle of the louvers.

4. The vehicle of claim 1, further comprising a radiator configured to dissipate heat from the heat-producing components, the radiator being in thermal contact and communication with the heat-producing components and being configured to receive the air provided from the outside the body, and wherein the rate of heat extraction from the heat-producing components depends on a heat exchange of the radiator, the heat exchange of the radiator depending on the position of the shutter.

5. The vehicle of claim 4, wherein the cost function further accounts for a cost of pumping coolant through the radiator, where the cost of pumping coolant through the radiator depends on the position of the shutter.

6. The vehicle of claim 1, further comprising a refrigerant compressor configured to compress a low temperature vapor a high temperature vapor, wherein the cost function further accounts for a cost of operating the compressor as a function of grille shutter position.

7. The vehicle of claim 1, wherein the cost function further accounts for a cost of changing the position of the shutter, such that the controller is configured to control the position of the shutter only by changing the position of the shutter if a change of the position of the shutter results in a change of the cost function, minus the cost of changing the position of the shutter, that exceeds a threshold amount.

8. A method of controlling an air intake of a vehicle, the method comprising;
determining a current position of a shutter that is configured for admitting air into the vehicle, the admitted air being used to dissipate heat from heat producing components within the vehicle;
determining a cost of operating the vehicle based the position of the shutter, the current cost being based on a first cost associated with an aerodynamic drag of the vehicle and a second cost associated with a rate of heat extraction from the heat-producing components, wherein the aerodynamic drag of the vehicle and the rate of heat extraction from the heat-producing components each depend on the position of the shutter;
comparing a first cost of operating the vehicle with the shutter in the current position to a second cost of operating the vehicle with the shutter in a proposed position, the proposed position being different from the current position; and
moving the shutter from the current position to the proposed position when the second cost is lower than the first cost.

9. The method of claim 8, wherein the heat-producing components include one or more of a battery, a power inverter, or an electric motor.

10. The method of claim 8, wherein the air intake includes a plurality of louvers and wherein moving the shutter from the current position to the proposed position include controlling an angle of the louvers.

11. The method of claim 8, wherein the vehicle includes a radiator configured to dissipate heat from the heat-producing components, the radiator being in thermal contact and communication with the heat-producing components and being configured to receive the air admitted into the vehicle, and wherein the rate of heat extraction from the heat-producing components depends on a heat exchange of the radiator, the heat exchange of the radiator depending on the position of the shutter.

12. The method of claim 11, wherein the cost function further accounts for a cost of pumping coolant through the radiator, where the cost of pumping coolant through the radiator depends on the position of the shutter.

13. The method of claim 8, wherein the vehicle further includes a refrigerant compressor configured to compress a low temperature vapor a high temperature vapor, and wherein the cost function further accounts for a cost of operating the compressor as a function of grille shutter position.

14. The vehicle of claim 8, wherein the cost function for operating the vehicle based on the position of the shutter being in the proposed position further accounts for a cost of changing the position of the shutter from the current position to the proposed position.
